(19) United States
(12) Patent Application Publication
(10) Pub. No.: US 2024/0271472 A1
(43) Pub. Date: Aug. 15, 2024

(54) Door Handle Assembly

(71) Applicant: Illinois Tool Works Inc., Glenview, IL (US)

(72) Inventors: Gang YU, Shanghai (CN); Bin CHEN, Shanghai (CN); Penghui YI, Shanghai (CN)

(21) Appl. No.: 18/438,734

(22) Filed: Feb. 12, 2024

(30) Foreign Application Priority Data
Feb. 13, 2023 (CN) 2023101509338
Jan. 22, 2024 (CN) 2024100882941

(51) Int. Cl. E05B 85/10; E05B 85/16

(52) U.S. Cl. CPC E05B 85/107; E05B 85/103; E05B 85/16

(57) ABSTRACT

The present disclosure provides a door handle assembly including a push rod, an ejector rod, a first movable rotating shaft and a second movable rotating shaft. The push rod has a push rod first end and a push rod second end, the ejector rod has an ejector rod first end and an ejector rod second end, the push rod second end is rotatably connected to the ejector rod first end via the first movable rotating shaft, the second movable rotating shaft is rotatably connected to the ejector rod between the ejector rod first end and the ejector rod second end. When the ejector rod abuts against the handle, the push rod applies a first pushing force to the ejector rod, the ejector rod applies a second pushing force to the handle, a component force of the second pushing force in a second direction is greater than the first pushing force.

### RELATED APPLICATIONS

The present application claims the benefit of Chinese Patent Application Nos. CN 2023101509338, filed Feb. 13, 2023, and CN 2024100882941, filed Jan. 22, 2024, each titled “Door Handle Assembly,” the contents of which are hereby incorporated by reference.

### TECHNICAL FIELD

The present disclosure relates to the technical field of vehicle components, and in particular to an electric icebreaking door handle assembly for a vehicle.

### BACKGROUND

When faced with low-temperature weather, an outside surface of a vehicle with a hidden or retractable handle may be covered with a layer of ice due to rain or snow, causing that the handle cannot be normally extended from a retracted position, so some handles are provided with an icebreaking mechanism.

### SUMMARY OF THE DISCLOSURE

The present disclosure relates generally to a handle and a door handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a handle of a door handle assembly in a retracted position according to the present disclosure.

FIG. 1B is a perspective view of the handle of the door handle assembly in a deployed position according to the present disclosure.

FIG. 1C is a top view of the door handle assembly as shown in FIG. 1A and a partially enlarged view of an ejector rod.

FIG. 1D is a force analysis diagram of the door handle assembly as shown in FIG. 1C.

FIG. 1E is a schematic view of an ejector rod in the door handle assembly shown in FIG. 1D when it rotates and pushes the handle upwardly.

FIG. 2 shows a top view of the handle shown in FIG. 1C in a move-up position and a partially enlarged view of the ejector rod.

FIG. 3 shows a top view of the handle shown in FIG. 1C in a deployed position and a partially enlarged view of the ejector rod.

FIG. 4 is a top view of the handle shown in FIG. 1C in a release position.

FIG. 5 is a schematic diagram of a vehicle having the door handle assembly according to the present disclosure.

### DETAILED DESCRIPTION OF EMBODIMENTS

Various specific embodiments of the present disclosure will be described below with reference to the accompanying drawings which constitute part of the present disclosure, but the embodiments would not limit the scope of the present disclosure. It should be understood that although the terms such as “upper”, “lower”, “left”, “right” and so on indicating directions are used in the present disclosure to describe orientations of various illustrative structural parts and elements in the present disclosure, the terms used herein are merely used for ease of description and are determined based on the illustrative orientation shown in the accompanying drawings. Since the embodiments disclosed in the present disclosure can be arranged in different orientations, the terms indicating directions are merely illustrative and should not be considered as limitations. In addition, the terms “first”, “second”, “third”, etc. used in the present disclosure are merely used to distinguish different objects, instead of indicating that there is any particular sequential relationship between these objects. The term “comprise/include” and derivatives thereof mean inclusion without limitation. Unless otherwise specified and limited, the terms “mount”, “couple” and “connect” should be understood broadly. For example, they may be mechanical or electrical connection, internal communication between two elements, or direct connection or indirect connection via an intermediate medium. For those of ordinary skills in the art, the specific meanings of the above terms can be understood according to specific cases. If possible, the same or similar reference numerals used in the present disclosure refer to the same components.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

According to a first aspect of the present disclosure, a door handle assembly is provided for driving a handle to move between a retracted position and one or more non-retracted positions. The door handle assembly comprises a push rod, an ejector rod, a first movable rotating shaft and a second movable rotating shaft. The push rod has a push rod first end and a push rod second end. The ejector rod has an ejector rod first end and an ejector rod second end, and the ejector rod second end is configured to be capable of abutting against the handle. The push rod second end is rotatably connected to the ejector rod first end via the first movable rotating shaft. The second movable rotating shaft is rotatably connected to the ejector rod between the ejector rod first end and the ejector rod second end. When the ejector rod and the handle abuts against each other, the push rod applies a first pushing force to the ejector rod, the ejector rod applies a second pushing force to the handle, and a component force of the second pushing force in a second direction is greater than the first pushing force.

According to the first aspect of the present disclosure, the distance between the axis of the first movable rotating shaft and the axis of the second movable rotating shaft is a first distance L₁. The first distance L₁ and the total length L of the ejector rod 112 meet:

$$\frac{{L}_{1}}{L} > \frac{1}{sin α cos α + 1} .$$

According to the first aspect of the present disclosure, the door handle assembly further comprises a push block and a third movable rotating shaft. The push block is configured to linearly reciprocate along a first direction. The push block is connected to the push rod first end via the third movable rotating shaft. The first direction and the second direction are perpendicular or substantially perpendicular to each other.

According to the first aspect of the present disclosure, the non-retracted positions comprise a move-up position, and the handle is movable between the retracted position and the move-up position. During the movement of the handle from the retracted position to the move-up position, the push block is configured to apply the first pushing force to the push rod in the first direction, to push the push rod to move in the first direction, the movement of the push rod in the first direction enables the ejector rod to rotate about the second movable rotating shaft, and the rotation of the ejector rod about the second movable rotating shaft enables the ejector rod second end of the ejector rod to apply the second pushing force to the handle.

According to the first aspect of the present disclosure, the handle is provided with an abutting block having an arc-shaped surface, and the ejector rod second end of the ejector rod is configured to abut against the handle via the abutting block. The ejector rod second end also has an arc-shaped surface, so that the ejector rod second end and the abutting block can slide relative to each other when they abut against each other.

According to the first aspect of the present disclosure, the handle is provided with a U-shaped ejector rod sliding groove, and an end of the second movable rotating shaft that opposite to the ejector rod is received in the ejector rod sliding groove. The second movable rotating shaft is configured to be translatable and rotatable in the ejector rod sliding groove.

According to the first aspect of the present disclosure, the door handle assembly further comprises a door handle support and a handle hinge assembly by which the handle is movably connected to the door handle support.

According to the first aspect of the present disclosure, the handle hinge assembly comprises a first rotating shaft, a fourth movable rotating shaft and a connecting rod. The connecting rod has a connecting rod first end and a connecting rod second end, the connecting rod first end is connected to the door handle support via the first rotating shaft, and the connecting rod second end is connected to the handle via the fourth movable rotating shaft.

According to the first aspect of the present disclosure, the non-retracted positions further comprise a deployed position, and the handle is movable between the move-up position and the deployed position. The push block is configured to abut against the connecting rod and apply a pushing force to the connecting rod during the movement of the handle from the move-up position to the deployed position.

According to the first aspect of the present disclosure, the handle hinge assembly further comprises a first torsion spring. The first torsion spring is mounted on the first rotating shaft and configured to abut between the connecting rod first end and the door handle support to provide a rotating force to rotate the connecting rod about the first rotating shaft in a clockwise direction, thereby enabling the connecting rod to have a tendency to move from the deployed position to the move-up position and to the retracted position.

According to the first aspect of the present disclosure, the handle hinge assembly further comprises a fifth movable rotating shaft, a sixth movable rotating shaft, a second rotating shaft, a pivoting arm and a pull rod. The pivoting arm has a pivot end and a swing end, and the pivot end is connected to the door handle support via the second rotating shaft. The pull rod has a pull rod first end and a pull rod second end, the pull rod first end is connected to the swing end of the pivoting arm via the sixth movable rotating shaft, and the pull rod second end is connected to the handle via the fifth movable rotating shaft.

According to the first aspect of the present disclosure, the door handle assembly further comprises an actuator configured to drive the push block to linearly reciprocate along the first direction.

According to a second aspect of the present disclosure, a door handle assembly for driving a handle to move between a retracted position and one or more non-retracted positions is provided. The door handle assembly comprises a push rod, an ejector rod, a first movable rotating shaft and a second movable rotating shaft. The push rod has a push rod first end and a push rod second end. The push rod is configured to be movable along a first direction. The ejector rod has an ejector rod first end and an ejector rod second end. The ejector rod second end is configured to push the handle along a second direction. The push rod second end is rotatably connected to the ejector rod first end via the first movable rotating shaft. The second movable rotating shaft is rotatably connected to the ejector rod between the ejector rod first end and the ejector rod second end. During the push rod pushing the ejector rod along the first direction, the ejector rod rotationally moves about the second movable rotating shaft, the second movable rotating shaft moves along the second direction and the angle between the ejector rod and the second direction gradually decreases such that the ejector rod second end pushes the handle from the retracted position to the one or more non-retracted positions along the second direction.

According to the second aspect of the present disclosure, the handle is provided with an ejector rod sliding groove extending along the second direction. An end of the second movable rotating shaft that opposite to the ejector rod is received in the ejector rod sliding groove. The second movable rotating shaft is configured to be movable along the second direction and rotatable in the ejector rod sliding groove. When the ejector rod rotationally moves about the second movable rotating shaft, the ejector rod sliding groove guides the ejector rod along the second direction to push the handle.

According to the second aspect of the present disclosure, the portion of the ejector rod second end pushing the handle is a smooth and/or continuous and gradual surface.

According to the second aspect of the present disclosure, the first direction is the length direction of the handle, the second direction is the direction in which the handle is deployed outwardly. The first direction and the second direction are perpendicular or substantially perpendicular to each other.

According to the second aspect of the present disclosure, the door handle assembly further comprises a push block and a third movable rotating shaft. The push block is configured to linearly reciprocate along a first direction. The push block is connected to the push rod first end via the third movable rotating shaft. The first direction and the second direction are perpendicular or substantially perpendicular to each other.

According to the second aspect of the present disclosure, the non-retracted positions comprise a move-up position, and the handle is movable between the retracted position and the move-up position. During the movement of the handle from the retracted position to the move-up position, the push block pushes the push rod to move along the first direction, the movement of the push rod along the first direction enables the ejector rod to rotate about the second movable rotating shaft, and the rotation of the ejector rod about the second movable rotating shaft enables the ejector rod second end of the ejector rod to push the handle to move.

According to the second aspect of the present disclosure, the handle is provided with an abutting block having an arc-shaped surface, and the ejector rod second end of the ejector rod pushes the handle to move via the abutting block.

According to the second aspect of the present disclosure, the door handle assembly further comprises a door handle support and a handle hinge assembly by which the handle is movably connected to the door handle support.

According to the second aspect of the present disclosure, the handle hinge assembly comprises a first rotating shaft, a fourth movable rotating shaft and a connecting rod. The connecting rod has a connecting rod first end and a connecting rod second end, the connecting rod first end is connected to the door handle support via the first rotating shaft, and the connecting rod second end is connected to the handle via the fourth movable rotating shaft.

According to the second aspect of the present disclosure, the non-retracted positions further comprise a deployed position, and the handle is movable between the move-up position and the deployed position. The push block is configured to push the connecting rod to move during the movement of the handle from the move-up position to the deployed position.

According to the second aspect of the present disclosure, the handle hinge assembly further comprises a first torsion spring. The first torsion spring is mounted on the first rotating shaft and configured to abut between the connecting rod first end and the door handle support to provide a rotating force to rotate the connecting rod about the first rotating shaft in a clockwise direction, thereby enabling the connecting rod to have a tendency to move from the deployed position to the move-up position and to the retracted position.

According to the second aspect of the present disclosure, the handle hinge assembly further comprises a fifth movable rotating shaft, a sixth movable rotating shaft, a second rotating shaft, a pivoting arm and a pull rod. The pivoting arm has a pivot end and a swing end, and the pivot end is connected to the door handle support via the second rotating shaft. The pull rod has a pull rod first end and a pull rod second end, the pull rod first end is connected to the swing end of the pivoting arm via the sixth movable rotating shaft, and the pull rod second end is connected to the handle via the fifth movable rotating shaft.

According to the second aspect of the present disclosure, the door handle assembly further comprises an actuator configured to drive the push block to linearly reciprocate along the first direction.

Some of the additional aspects and advantages of the present disclosure will be set forth in the following description, and some will become apparent from the following description, or be learned by practice of the present disclosure.

As described below, a handle 102 of a door handle assembly 100 according to the present disclosure has, during use, a retracted position and several non-retracted positions, including a move-up position, a deployed position and a release position. The movement of the handle 102 from the retracted position to the move-up position or the deployed position is actuated by an actuator 106, and the movement of the handle 102 from the deployed position to the release position is actuated by an external mechanical pulling force.

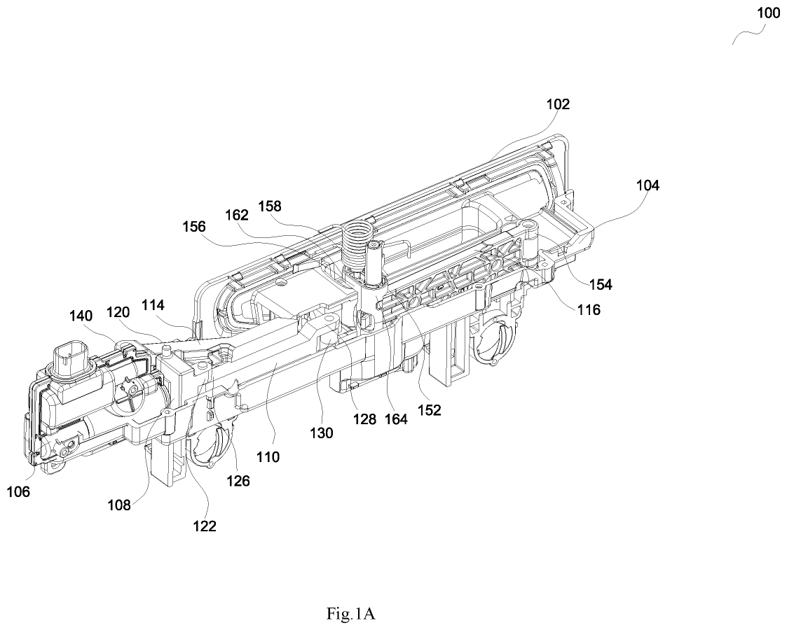

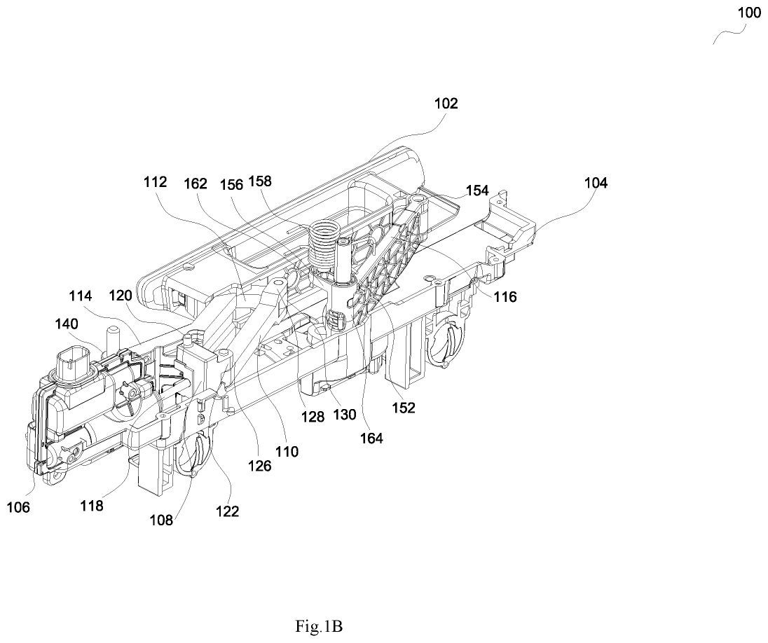

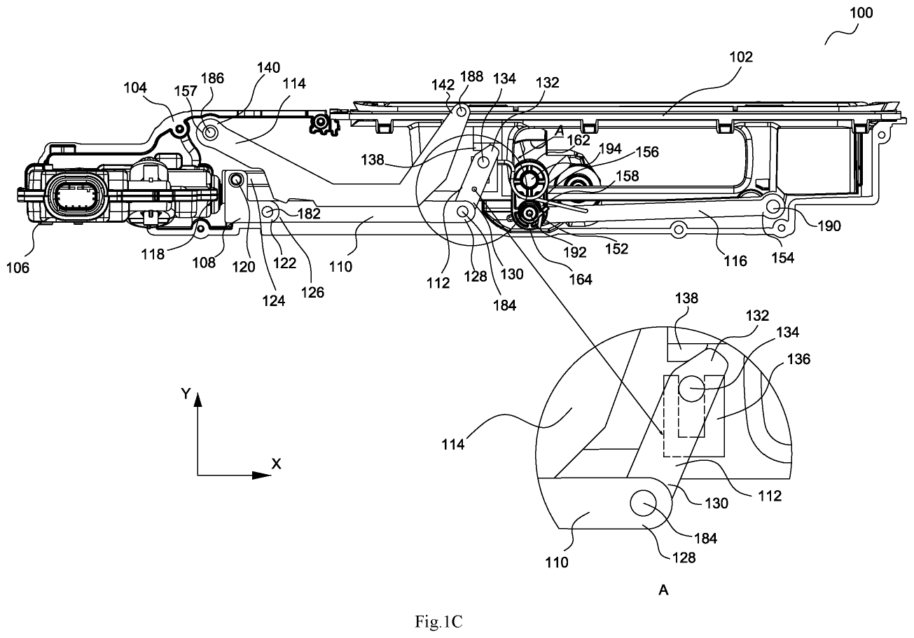

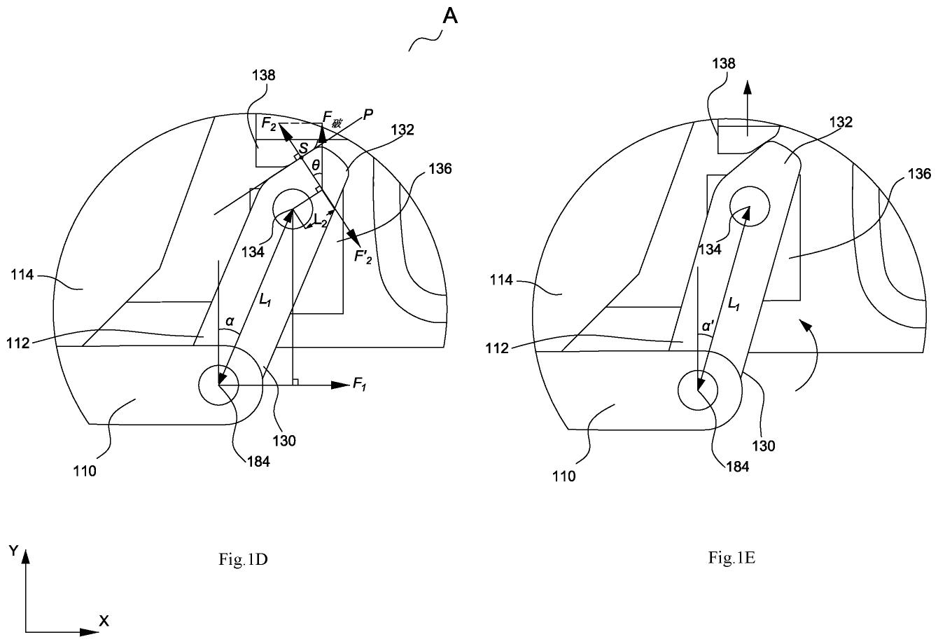

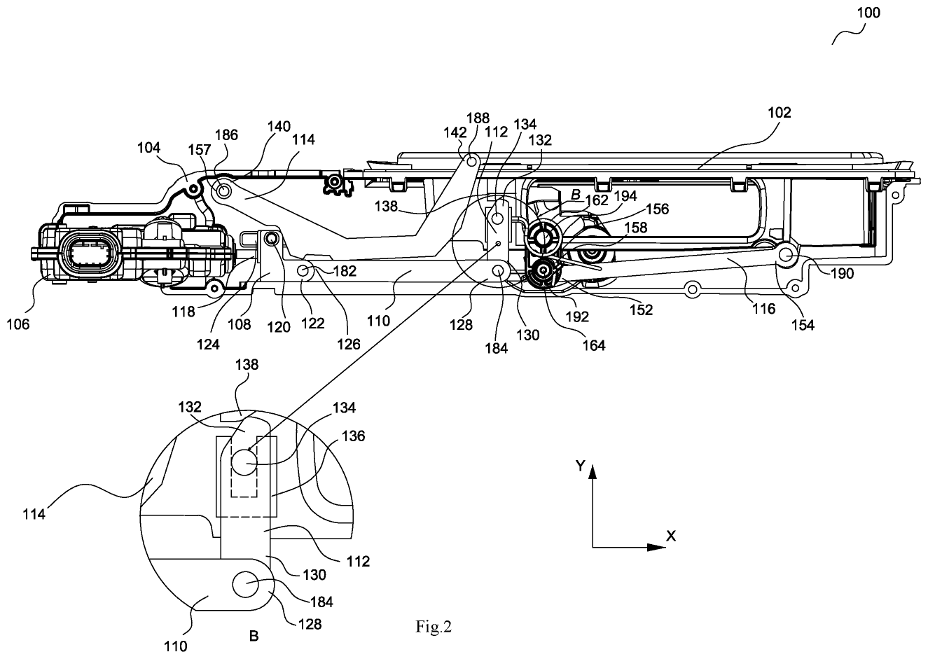

FIG. 1A and FIG. 1B respectively show a perspective view of the handle 102 of the door handle assembly 100 according to the present disclosure in the retracted position and the deployed position. To illustrate more details of an ejector rod 112, a connecting rod 114 and their surrounding areas, some of the structures of the handle 102 is hidden in FIG. 1C, in which the door handle assembly 100 in FIG. 1A is shown from a top view. FIG. 1D further analyzes the forces on the ejector rod 112 and its adjacent components shown in FIG. 1C through an enlarged view. FIG. 1E is a schematic view of the ejector rod 112 in the door handle assembly shown in FIG. 1D when it rotates and pushes the handle 102 upwardly.

As shown in FIG. 1A to FIG. 1C, the door handle assembly 100 of the present disclosure has the handle 102, a handle support 104, and a handle hinge assembly for movably connecting the handle 102 to the door handle support 104. The handle hinge assembly comprises the connecting rod 114, a pull rod 116 and a pivoting arm 156, as well as a first torsion spring 157, a second torsion spring 158, a first rotating shaft 186, a fourth movable rotating shaft 188, a fifth movable rotating shaft 190, a sixth movable rotating shaft 192 and a second rotating shaft 194. The handle 102 is mounted on the handle support 104 via the connecting rod 114, the pull rod 116 and the pivoting arm 156.

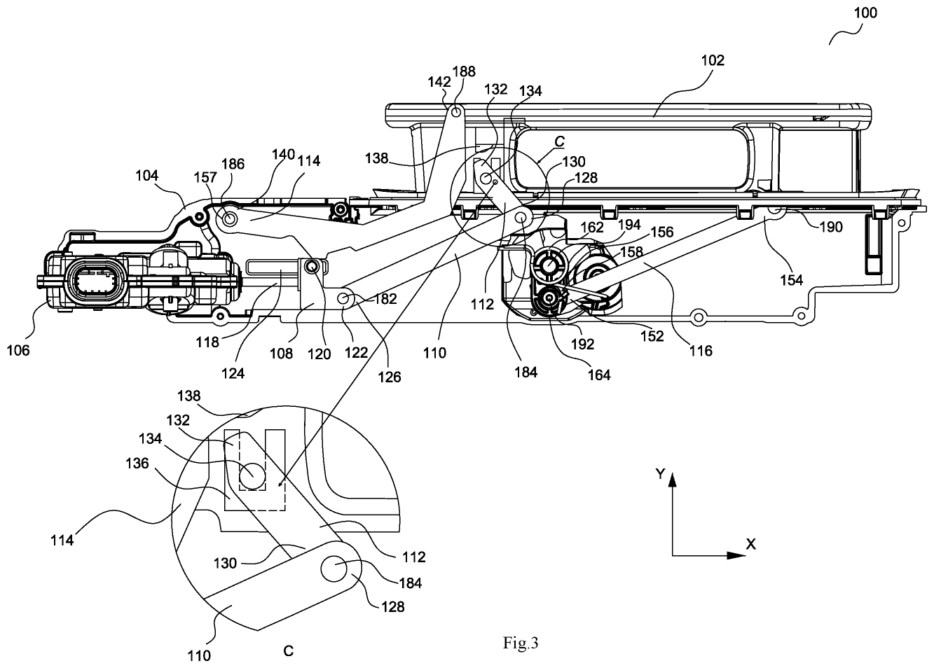

Specifically, the connecting rod 114 has a connecting rod first end 140 and a connecting rod second end 142. The connecting rod first end 140 is connected to the door handle support 104 via the first rotating shaft 186, and the connecting rod second end 142 is connected to the handle 102 via the fourth movable rotating shaft 188. The pivoting arm 156 has a pivot end 162 and a swing end 164, and the pivot end 162 is connected to the door handle support 104 via the second rotating shaft 194. The pull rod 116 has a pull rod first end 152 and a pull rod second end 154, the pull rod first end 152 is connected to the swing end 164 of the pivoting arm 156 via the sixth movable rotating shaft 192, and the pull rod second end 154 is connected to the handle 102 via the fifth movable rotating shaft 190. During the movement of the handle 102 from the retracted position (a position shown in FIG. 1A and FIG. 1C) to the move-up position (a position shown in FIG. 2) or the deployed position (a position shown in FIG. 1B and FIG. 3), the pivoting arm 156 does not rotate or move, so the handle 102, the door handle support 104, the connecting rod 114 and the pull rod 116 can form a four-bar linkage in the above movement.

The door handle assembly 100 of the present disclosure further has the actuator 106, a push block 108, a push rod 110 and the ejector rod 112 arranged on the handle support 104, and also has a third movable rotating shaft 182, a first movable rotating shaft 184 and a second movable rotating shaft 134.

Specifically, the actuator 106 has an actuator push rod 118 snap-fitted to the push block 108, the actuator push rod 118 is movable linearly along the length direction of the handle 102 (“X direction” or “the first direction X” hereinafter) by the actuation of the actuator 106, so as to drive the push block 108 to move. The push block 108 has a push block sliding pin 120 and a push block articulating portion 122, one end of the push block sliding pin 120 is secured to the side of the push block 108 facing the handle support 104, and the other end of the push block sliding pin 120 can be accommodated in a push block sliding groove 124 (see FIG. 1C) provided in a bottom surface of the handle support 104. Since the direction of the push block sliding groove 124 is arranged along the X direction, and the width thereof matches the diameter of the push block sliding pin 120, the push block 108 can only move linearly along the X direction, and cannot move in other directions, for example, it cannot move along a direction in which the handle 102 is deployed outwardly (“Y direction” or “the second direction X” hereinafter). The push rod 110 has a push rod first end 126 and a push rod second end 128, the push rod first end 126 is connected to the push block articulating portion 122 of the push block 108 via the third movable rotating shaft 182. The ejector rod 112 has an ejector rod first end 130 and an ejector rod second end 132, the ejector rod first end 130 is connected to the push rod second end 128 of the push rod 110 via the first movable rotating shaft 184, and the ejector rod second end 132 is configured to be capable of abutting against the handle 102. One end of the second movable rotating shaft 134 is rotatably secured to the side of the ejector rod 112 facing the handle support 104, and is in a position between the ejector rod first end 130 and the ejector rod second end 132, so that the second movable rotating shaft 134 can serve as a rotation shaft of the ejector rod 112.

The X direction and the Y direction are perpendicular to each other. However, for those of at least ordinary skill in the art, there are inevitably manufacturing tolerances or errors in an actual manufacturing process, so the X and Y directions can also be substantially perpendicular to each other, and the error range is within 5 degrees.

As shown in the partially enlarged view at the bottom right of FIG. 1C, the handle 102 is further provided with a U-shaped ejector rod sliding groove 136 extending in the Y direction and an abutting block 138 with an arc-shaped surface at one end. The other end of the second movable rotating shaft 134 opposite to the ejector rod 112 is accommodated in the ejector rod sliding groove 136, thereby allowing the second movable rotating shaft 134 to rotate while also translating in the ejector rod sliding groove 136. Therefore, the ejector rod 112 can rotate about the second movable rotating shaft 134 while translating relative to the handle 102. The ejector rod sliding groove 136 actually serves to guide the movement of the ejector rod 112, i.e., when the ejector rod 112 rotates about the second movable rotating shaft 134, through the rotation and movement of the second movable rotating shaft 134 in the ejector rod sliding groove 136, the ejector rod sliding groove 136 guides the ejector rod second end 132 toward the handle 102 along the Y direction so that it can push the handle 102. The ejector rod second end 132 has a smooth arc-shaped surface or a flat surface, and when pushing the handle 102, the ejector rod second end 132 abuts against the handle 102 via the abutting block 138. The ejector rod second end 132 may also not abut against the abutting block 138 when it does not push the handle 102. The contact surface of the abutting block 138 with the ejector rod second end 132 may be a smooth surface, and the portion of the ejector rod second end 132 pushing the handle 102 is a smooth and/or continuous and gradual surface to reduce the friction generated when the ejector rod 112 and the abutting block 138 slide relative to each other.

The door handle assembly 100 of the present disclosure further has the first torsion spring 157 and a second torsion spring 158. The first torsion spring 157 is mounted on the first rotating shaft 186 and abuts between the connecting rod first end 140 and the door handle support 104 to provide a rotating force to rotate the connecting rod 114 about the first rotating shaft 186 in a clockwise direction, so as to enable the connecting rod 114 to have a tendency to move from the deployed position to the move-up position and to the retracted position. The second torsion spring 158 is mounted on the second rotating shaft 194 and abuts between the swing end 164 of the pivoting arm 156 and the door handle support 104 (in order to illustrate various components of the door handle assembly 100, on the basis of not affecting the understanding of the summary of the disclosure in the present disclosure, the parts of the door handle support 104 abutting against the first torsion spring 157 and the second torsion spring 158 are hidden in FIG. 1A and FIG. 1B) to provide a pivoting force pivoting the pivoting arm 156 in a clockwise direction about the second rotating shaft 194 so as to enable the handle 102 to have a tendency to move from the release position to the deployed position.

FIG. 1D is a force analysis diagram of the door handle assembly 100 as shown in FIG. 1C. As shown in FIG. 1D, in combination with various components of the door handle assembly 100 as shown in FIG. 1C, under the actuation of the actuator 106, the actuator push rod 118 can apply an acting force F₁ (a first pushing force) along the X direction to the push block 108, thereby causing the push block 108 to move rightward along the X direction. The rightward movement of the push block 108 can transfer the acting force F₁ from the actuator push rod 118 to the push rod 110, thereby causing the push rod 110 to move rightward along the X direction. The rightward movement of the push rod 110 can transfer the acting force F₁ in the X direction to the ejector rod 112, thereby causing the ejector rod 112 to rotate about the second movable rotating shaft 134. The rotation of the ejector rod 112 about the second movable rotating shaft 134 can apply an acting force F₂ (a second pushing force) on the abutting block 138 of the handle 102.

The surface of the ejector rod second end 132 and the surface of the abutting block 138 of the handle 102 in contact with each other are curved surfaces or flat surfaces (since FIGS. 1C-1D are orthographic projection views, the contact surfaces of the ejector rod and the handle are illustrated as curved or straight lines). In the embodiment shown in FIG. 1C, the abutting block 138 of the handle 102 contacts a flat surface of the ejector rod second end 132 through a curved surface, and thus the contact portion between the abutting block 138 of the handle 102 and the ejector rod second end 132 is illustrated as a contact line S perpendicular to the paper surface (see FIG. 1D, and since FIG. 1D is an orthographic projection view, the contact line S is illustrated as a point). There exists a plane P that contains the contact line S while being tangent to the contact surface of the abutting block 138 of the handle 102, and at the same time coincides with the flat surface of the ejector rod second end 132 in contact with the abutting block 138. This plane is a common tangent plane P between the abutting block 138 of the handle 102 and the ejector rod second end 132. FIG. 1D illustrates this common tangent plane P. Since FIG. 1D is an orthographic projection view, the common tangent plane P is illustrated as a straight line. For those of ordinary skill in the art, the ejector rod second end 132 may also be in contact with the curved surface or a flat surface of the abutting block 138 via a curved surface, and a corresponding common tangent plane P may likewise be found that is tangent to the curved surface of the ejector rod second end 132, and is tangent to the curved surface of the abutting block 138 or coincides with the flat surface of the abutting block 138. If the ejector rod second end 132 is in contact with the flat surface of the abutting block 138 through a flat surface, a corresponding common tangent plane can also be found that coincides with the flat surface of the ejector rod second end 132 that in contact with the flat surface of the abutting block 138.

The point of action of the acting force F₂ applied by the ejector rod second end 132 on the abutting block 138 of the handle 102 is on the contact line S and the acting force F₂ is perpendicular to the common tangent plane P. According to Newton's third law, the abutting block 138 of the handle 102 applies a reaction force F₂′ on the ejector rod 112. The magnitude of the reaction force F₂′ is equal to the magnitude of the force F₂, the point of action of the reaction force F₂′ is also on the contact line S, and the direction of the reaction force F₂′ is opposite to the direction of the force F₂, i.e., it is also perpendicular to the common tangent plane P.

For the ejector rod 112, it is subjected to the rightward acting force F₁ applied by the push rod 110 and the above-described reaction force F₂′ applied by the abutting block 138 of the handle 102. According to the lever principle, the force arm length of the acting force F₁ is the distance from the axis of the second movable rotating shaft 134 to the acting force F₁, i.e., the value of the projection of the distance L₁ between the axis of the first movable rotating shaft 184 and the axis of the second movable rotating shaft 134 in the Y direction, namely, L₁×cos α. The force arm length L₂ of the reaction force F₂′ is the distance from the axis of the second movable rotating shaft 134 to the reaction force F₂′. If the force arm length L₂ of the reaction force F₂′ is approximated as the distance from the axis of the second movable rotating shaft 134 to the edge of the ejector rod second end 132, then the total length L of the ejector rod 112 may be approximated to be equal to the sum of the distance L₁ and the distance L₂. The following formula can be obtained based on the principle of leverage:

$${F}_{1} \times {L}_{1} \times cos α = {F}_{2}^{′} \times {L}_{2} ∘$$

The effective ice-breaking force F_{B} is the force of the ejector rod 112 on the handle 102 in a direction perpendicular to the external ice surface of the handle 102 (Y direction), i.e., the component force of the acting force F₂ in the Y direction. Since the direction of the acting force F₂ is at an included angle θ from the Y direction (i.e. the direction perpendicular to the direction of the ice surface outside the handle 102), the component force of the acting force F₂ in the Y direction is F₂ cos θ, i.e., the effective ice-breaking force F_{B}=F₂×cos θ. If the direction in which the acting force F₂ is located is approximated as the direction perpendicular to the ejector rod 112, the angle θ and the angle α are cosine angles to each other, and the effective ice-breaking force F_{B}=F₂×sin α.

In an embodiment of the present disclosure, the ratio of L₁ to L₂ is about 5, the included angle θ is about 30°, and it can be calculated that the component force of the acting force F₂ in the Y direction is 8.7 times that of the acting force F₁. Therefore, in the present disclosure, a lever mechanism composed of the push rod 110, the ejector rod 112 and the abutting block 138 is a labor-saving lever, and the acting force F₁ from the actuator push rod 118 in the X direction can be amplified by 8.7 times and applied to the handle 102 in the Y direction. Therefore, when an outer surface of a deployable handle 102 is frozen, the door handle assembly 100 of the present disclosure can amplify by 8.7 times the acting force output by the actuator 106 at the retracted position of the handle 102 and then apply the force to an ice layer.

With reference to FIGS. 1D-1E, it can be seen that in the process of breaking the ice, the push rod 110 pushes the ejector rod first end 130 rightwards, causing the ejector rod 112 to rotate counterclockwise about the second movable rotating shaft 134, so that the ejector rod 112 is gradually close to the Y direction, i.e., the angle α between the ejector rod 112 and the Y direction is gradually reduced (e.g., reduced to the angle α′ in FIG. 1E), thereby causing the ejector rod second end 132 to move upwardly and push the abutting block 138 of the handle 102 to move. During the counterclockwise rotation of the ejector rod 112, the force arm length L₁×cos α of the acting force F₁ gradually increases, and the angle θ between the acting force F₂ and the Y direction gradually decreases, resulting in a gradual increase of the effective ice-breaking force F_{B}=F₂×sin α. According to the above formula, it can be seen that the process of breaking ice is a process of applying a gradually decreasing force, i.e., the actuator push force required at the starting moment of breaking ice is the largest, and with the counterclockwise rotation of the ejector rod 112, the amplification of the actuator push force is gradually increased, so that the door handle assembly 100 of the present disclosure can at least amplify the acting force outputted by the actuator 106 by a factor of 8.7 times to apply to the ice layer.

For those with at least ordinary skill in the art, in some other embodiments, the ratio of the values of L₁/L₂ is not necessarily 5, and the magnitudes of the angle θ and the angle α can be other values, the effect of the force-saving lever can be realized as long as the relative positions of the push rod 110, the ejector rod 112, and the handle are arranged as in the working principle of the present disclosure and the second movable rotating shaft 134 is arranged at an appropriate position of the ejector rod 112 such that component force of the acting force F₂ in the Y direction is greater than the acting force F₁. Specifically, in order to realize that the component force of the acting force F₂ in the Y direction is greater than the acting force F₁, the distance L₁ between the axis of the second movable rotating shaft 134 and the axis of the first movable rotating shaft 184 and the total length L of the ejector rod 112 needs to approximately meet the following formula:

$$\frac{{L}_{1}}{L} > \frac{1}{sin α cos α + 1} .$$

FIG. 2 shows a top view of the handle 102 shown in FIG. 1C in the move-up position and a partially enlarged view of the ejector rod 112.

As shown in FIG. 2, the ejector rod 112 is rotated and moved from the orientation at the included angle θ from the Y direction in FIG. 1C to the orientation in the Y direction in FIG. 2, so that the ejector rod 112 can push upward the abutting block 138 of the handle 102 along the Y direction to lift the handle 102 from the retracted position to the move-up position, thereby completing the icebreaking operation. As previously described, the handle 102, the door handle support 104, the connecting rod 114 and the pull rod 116 can form a four-bar linkage. Therefore, during the movement of the handle 102 being lifted from the retracted position to the move-up position, the connecting rod 114 and the pull rod 116 also correspondingly rotate counterclockwise about the first rotating shaft 186 and the sixth movable rotating shaft 192.

It should be noted that, in an embodiment of the present disclosure, the push block 108 does not come in contact with the connecting rod 114 during the movement of the handle 102 from the retracted position to the move-up position (see FIG. 1C). When the handle 102 moves to the move-up position as shown in FIG. 2, the push block 108 begins to make contact with the connecting rod 114. For those of at least ordinary skill in the art, in some other embodiments, the push block 108 can also make contact with the connecting rod 114 before the handle 102 moves to the move-up position, as long as there is no interference between the rotation of the connecting rod 114 and the push of the ejector rod 112 against the abutting block 138.

FIG. 3 shows a top view of the handle 102 shown in FIG. 1C in the deployed position and a partially enlarged view of the ejector rod 112.

As shown in FIG. 3, when the actuator push rod 118 continues to push the push block 108 in the X direction, the push block 108 continues to move rightward in the X direction, so that the push block 108 abut against the connecting rod 114 and push the connecting rod 114 to rotate counterclockwise about the first rotating shaft 186, and the rotation of the connecting rod 114 can drive the handle 102 and the pull rod 116 in the four-bar linkage to rotate or move together. When the connecting rod 114 rotates to a position (a position shown in FIG. 3) where the push block 108 cannot continue to push, a portion of the connecting rod 114 rests over the push block 108, and the handle 102 is moved to the deployed position. During the movement of the handle 102 from the move-up position to the deployed position, the ejector rod 112 is out of contact with the abutting block 138 of the handle 102, the movement of the handle 102 drives the second movable rotating shaft 134, the ejector rod 112 and the push rod 110 to move accordingly through the U-shaped ejector rod sliding groove 136, and the ejector rod 112 applies no acting force to the abutting block 138 of the handle 102.

It should be noted that, under the action of the second torsion spring 158, the counterclockwise rotation of the connecting rod 116 about the sixth movable rotating shaft 192 does not drive the pivoting arm 156 to pivot counterclockwise about the second rotating shaft 194, because the second torsion spring 158 can provide a pivoting force against the counterclockwise pivoting of the pivoting arm 156 about the second rotating shaft 194, and the friction generated by the rotation of the connecting rod 116 alone is not sufficient to overcome the pivoting force provided by the second torsion spring 158. Therefore, during the movement of the handle 102 from the retracted position to the move-up position and to the deployed position, the pivoting arm 156 does not rotate.

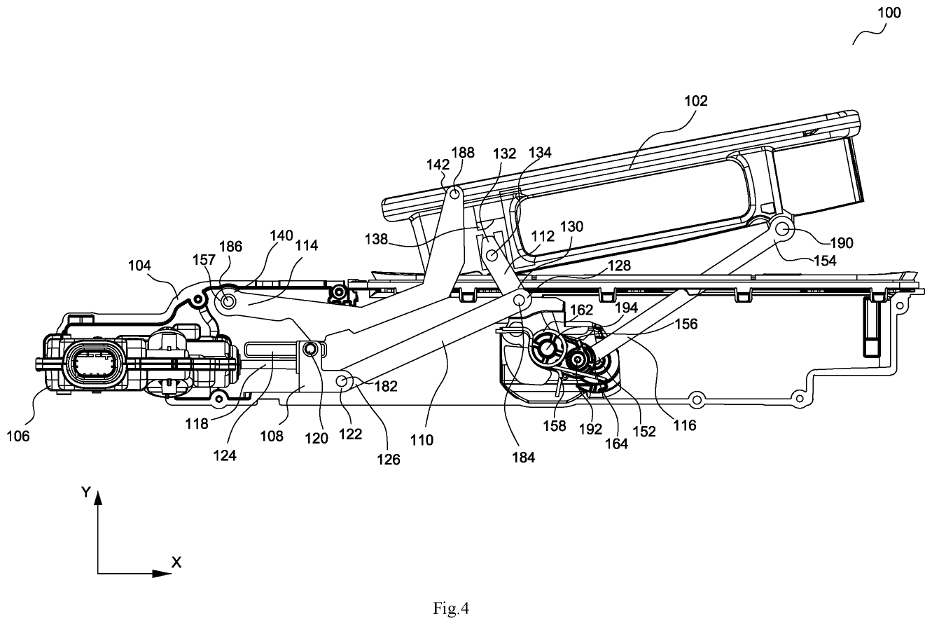

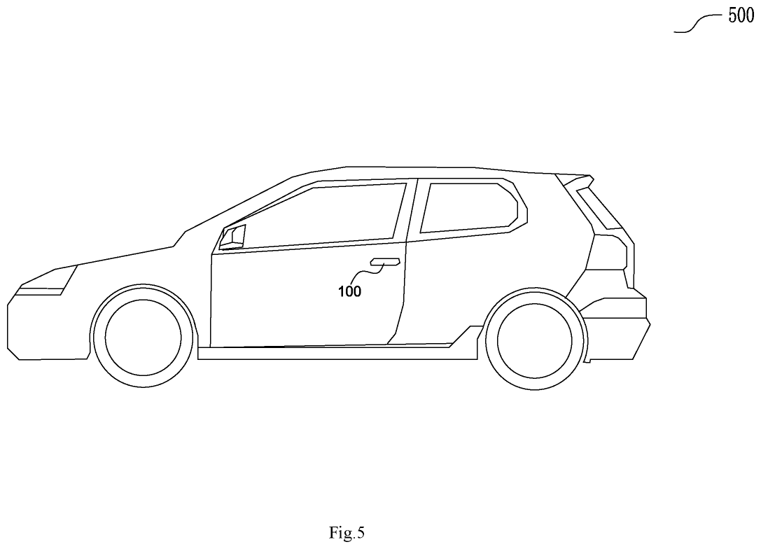

FIG. 4 is a top view of the handle 102 shown in FIG. 1C in the release position.

As shown in FIG. 4, when the handle 102 moves to the deployed position, a large portion of the structure of the handle 102 is exposed outside the handle support 104, and at this point, a driver or a passenger may pull the handle 102 toward the outside of a vehicle door, so as to drive the pull rod 116 to pull the swing end 164 of the pivoting arm 156 to rotate, and the magnitude of this pulling force should be sufficient to overcome the pivoting force of the second torsion spring 158, thus, the pivoting arm 156 rotates counterclockwise about the second rotating shaft 194, and the handle 102 then moves to the release position. The door handle assembly 100 of the present disclosure further has a mechanical transmission member, such as a Bowden cable transmission member, which is connected to the pivoting arm 156. The counterclockwise rotation of the pivoting arm 156 can drive the mechanical transmission member to move, so as to mechanically unlock the door.

When the driver or the passenger releases the handle 102, that is, when the aforementioned pulling force is removed, the pivoting arm 156 can rotate clockwise back to its initial position under the action of the pivoting force of the second torsion spring 158 to drive the pull rod 116 to move via the swing end 164, thereby causing the handle 102 to move from the release position back to the deployed position. When the handle 102 is in the deployed position, the actuator 106 can retract the actuator push rod 118 leftward in the X direction to a limit position by reverse actuation, thereby driving the push block 108 that is snap-fitted to the actuator push rod 118 to move leftward along the X direction, and thereby driving the push rod 110 and the ejector rod 112 to move toward the initial position shown in FIG. 1C. The ejector rod 112 can abut against the lower side of the U-shaped ejector rod sliding groove 136 via the second movable rotating shaft 134 connected thereto (see FIG. 1C), so as to drive the ejector rod sliding groove 136 to move downward, thereby moving the handle 102 to the retracted position.

FIG. 5 is a schematic diagram of a vehicle 500 having the door handle assembly 100 of the present disclosure, which illustrates an application scenario of the door handle assembly 100 of the present disclosure. As shown in FIG. 5, the door handle assembly 100 is mounted on the outside of a door of the vehicle 500, and an ice layer covering the outside of the door can be broken by the approach described above. The vehicle 500 in FIG. 5 is merely an example, the door handle assembly 100 of the present disclosure may also be mounted in other positions of the vehicle according to different needs, such as on a trunk door or sunroof, or on other devices or buildings with doors.

In order to realize an icebreaking function, there are the following two icebreaking solutions in the prior art: an electric heating icebreaking mechanism or a mechanical press icebreaking mechanism. The electric heating icebreaking mechanism incorporates a heating plate structure into the design of a handle, and the heating plate heats up the handle to melt the ice, after which the handle can be normally deployed. The mechanical press icebreaking mechanism provides an elastic mechanism on the handle to break an ice layer by pressing the end of the handle. After ice breaking is completed, the elastic mechanism can provide a reset force to support the handle, so that the handle can be normally deployed.

However, the electric heating icebreaking mechanism is not only energy-consuming, costly, and occupies a layout space, but also affects the icebreaking efficiency due to the long operation time, and also affects the service life of plastic parts of the handle due to repeated heating over a long period of time, so its application has limitations. The mechanical press icebreaking mechanism needs to overcome the acting force of the ice layer itself and the elastic force of the elastic mechanism at the same time to apply a pressing force, resulting in the need for a large press force, which usually needs to reach more than 60 N, thus affecting the comfort of the user when opening the door.

Therefore, the present disclosure utilizes the lever principle to provide an electric icebreaking handle with an icebreaking mechanism of a labor-saving lever.

The door handle assembly of the present disclosure, on the basis of the existing door handle assembly structure, realizes a labor-saving lever mechanism by adding only a push rod and an ejector rod, which has the following advantages over the door handle assembly in the prior art.

Firstly, compared with a door handle assembly with an electric heating icebreaking mechanism, the door handle assembly of the present disclosure uses a pure mechanical design, which has low energy consumption and a simple structure, and thus has a lower overall cost. In addition, there is no need to wait for the ice layer to melt as in the case of the electric heating icebreaking mechanism, so the door handle assembly of the present disclosure performs icebreaking operation in a shorter and more efficient manner, and also avoids shortening the service life of the plastic parts of the handle due to repeated heating over a long period of time.

Secondly, compared with a door handle assembly with a mechanical press-type icebreaking mechanism, the door handle assembly of the present disclosure can realize an icebreaking operation without any pressing force applied by the user, which can bring the user a more comfortable experience of opening the door. In addition, since the door handle assembly of the present disclosure has a mechanical structure of a labor-saving lever, as mentioned above, the acting force provided by the actuator can be amplified by at least 8.7 times for the icebreaking operation, so that the working load of the actuator will not be increased too much.

Although the present disclosure is described with respect to the examples of the embodiments outlined above, various alternatives, modifications, variations, improvements, and/or substantial equivalents that are known or current or to be anticipated later may be apparent to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or can solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

What is claimed is:

1. A door handle assembly (100) for driving a handle (102) to move between a retracted position and one or more non-retracted positions, the door handle assembly comprising:
a push rod (110) having a push rod first end (126) and a push rod second end (128); and
an ejector rod (112) having an ejector rod first end (130) and an ejector rod second end (132), the ejector rod second end (132) being configured to be capable of abutting against the handle (102);
a first movable rotating shaft (184); and
a second movable rotating shaft (134);
wherein the push rod second end (128) is rotatably connected to the ejector rod first end (130) via the first movable rotating shaft (184),
wherein the second movable rotating shaft (134) is rotatably connected to the ejector rod (112) between the ejector rod first end (130) and the ejector rod second end (132), and
wherein when the ejector rod (112) and the handle (102) abut against each other, the push rod (110) applies a first pushing force (F₁) to the ejector rod (112), the ejector rod (112) applies a second pushing force (F₂) to the handle (102), the component force of the second pushing force (F₂) in a second direction (Y) being greater than the first pushing force (F₁).

2. The door handle assembly of claim 1, wherein
a distance between an axis of the first movable rotating shaft (184) and an axis of the second movable rotating shaft (134) is a first distance (L₁);
wherein the first distance (L₁) and a total length (L) of the ejector rod (112) meet:
$$\frac{{L}_{1}}{L} > \frac{1}{sin α cos α + 1} .$$

3. The door handle assembly of claim 2, further comprising:
a push block (108) configured to linearly reciprocate along a first direction (X); and
a third movable rotating shaft (182),
wherein the push block (108) is connected to the push rod first end (126) via the third movable rotating shaft (182), and
wherein the first direction (X) and the second direction (Y) are perpendicular or substantially perpendicular to each other.

4. The door handle assembly of claim 3, wherein
the non-retracted positions comprise a move-up position, and the handle (102) is movable between the retracted position and the move-up position;
wherein during movement of the handle (102) from the retracted position to the move-up position, the push block (108) is configured to apply the first pushing force (F₁) to the push rod (110) along the first direction (X), to push the push rod (110) to move along the first direction (X), movement of the push rod (110) along the first direction (X) enables the ejector rod (112) to rotate about the second movable rotating shaft (134), and the rotation of the ejector rod (112) about the second movable rotating shaft (134) enables the ejector rod second end (132) of the ejector rod (112) to apply the second pushing force (F₂) to the handle (102).

5. The door handle assembly of claim 4, wherein
the handle (102) is provided with an abutting block (138) having an arc-shaped surface, the ejector rod second end (132) of the ejector rod (112) being configured to abut against the handle (102) via the abutting block (138); and
the ejector rod second end (132) also has an arc-shaped surface, so that the ejector rod second end (132) and the abutting block (138) can slide relative to each other when they abut against each other.

6. The door handle assembly of claim 4, wherein
the handle (102) is provided with a U-shaped ejector rod sliding groove (136), an end of the second movable rotating shaft (134) that opposite to the ejector rod (112) is received in the ejector rod sliding groove (136), wherein the second movable rotating shaft (134) is configured to be translatable and rotatable in the ejector rod sliding groove (136).

7. The door handle assembly of claim 5, further comprising:
a door handle support (104); and
a handle hinge assembly by which the handle (102) is movably connected to the door handle support (104).

8. The door handle assembly of claim 3, wherein the door handle assembly (100) further comprises:
an actuator (106) configured to drive the push block (108) to linearly reciprocate along the first direction (X).

9. A door handle assembly (100) for driving a handle (102) to move between a retracted position and one or more non-retracted positions, the door handle assembly comprising:
a push rod (110) having a push rod first end (126) and a push rod second end (128), the push rod (110) being configured to be movable along a first direction (X); and
an ejector rod (112) having an ejector rod first end (130) and an ejector rod second end (132), the ejector rod second end (132) being configured to push the handle (102) along a second direction (Y);
a first movable rotating shaft (184), wherein the push rod second end (128) is rotatably connected to the ejector rod first end (130) via the first movable rotating shaft (184); and
a second movable rotating shaft (134) being rotatably connected to the ejector rod (112) between the ejector rod first end (130) and the ejector rod second end (132);
wherein, during the push rod (110) pushing the ejector rod (112) along the first direction (X), the ejector rod (112) rotationally moves about the second movable rotating shaft (134), the second movable rotating shaft (134) moves along the second direction (Y) and an angle between the ejector rod (112) and the second direction (Y) gradually decreases such that the ejector rod second end (132) pushes the handle (102) from the retracted position to the one or more non-retracted positions along the second direction (Y).

10. The door handle assembly of claim 9, wherein
the handle (102) is provided with an ejector rod sliding groove (136) extending along the second direction (Y), an end of the second movable rotating shaft (134) that opposite to the ejector rod (112) being received in the ejector rod sliding groove (136);
wherein the second movable rotating shaft (134) is configured to be movable along the second direction (Y) and rotatable in the ejector rod sliding groove (136); and
wherein when the ejector rod (112) rotationally moves about the second movable rotating shaft (134), the ejector rod sliding groove (136) guides the ejector rod (112) along the second direction (Y) to push the handle (102).

11. The door handle assembly of claim 9, wherein
a portion of the ejector rod second end (132) pushing the handle (102) is a smooth and/or continuous and gradual surface.

12. The door handle assembly of claim 9, wherein
the first direction (X) is a length direction of the handle (102), the second direction (Y) is the direction in which the handle (102) is deployed outwardly, wherein the first direction (X) and the second direction (Y) are perpendicular or substantially perpendicular to each other.

13. The door handle assembly of claim 10, further comprising:
a push block (108) configured to linearly reciprocate along the first direction (X); and
a third movable rotating shaft (182);
wherein the push block (108) is connected to the push rod first end (126) via the third movable rotating shaft (182), and
wherein the first direction (X) and the second direction (Y) are perpendicular or substantially perpendicular to each other.

14. The door handle assembly of claim 13, wherein
the non-retracted positions comprise a move-up position, and the handle (102) is movable between the retracted position and the move-up position;
wherein during movement of the handle (102) from the retracted position to the move-up position, the push block (108) pushes the push rod (110) to move along the first direction (X), movement of the push rod (110) along the first direction (X) enables the ejector rod (112) to rotate about the second movable rotating shaft (134), and the rotation of the ejector rod (112) about the second movable rotating shaft (134) enables the ejector rod second end (132) of the ejector rod (112) to push the handle (102) to move.

15. The door handle assembly of claim 14, wherein
the handle (102) is provided with an abutting block (138) having an arc-shaped surface, wherein the ejector rod second end (132) of the ejector rod (112) pushes the handle (102) to move via the abutting block (138).

16. The door handle assembly of claim 15, further comprising:
a door handle support (104); and
a handle hinge assembly by which the handle (102) is movably connected to the door handle support (104).

17. The door handle assembly of claim 16, wherein the handle hinge assembly comprises:
a first rotating shaft (186);
a fourth movable rotating shaft (188); and
a connecting rod (114) having a connecting rod first end (140) and a connecting rod second end (142),
wherein the connecting rod first end (140) is connected to the door handle support (104) via the first rotating shaft (186), and wherein the connecting rod second end (142) is connected to the handle (102) via the fourth movable rotating shaft (188).

18. The door handle assembly of claim 17, wherein
the non-retracted positions further comprise a deployed position, the handle (102) being movable between the move-up position and the deployed position;
wherein the push block (108) is configured to push the connecting rod (114) to move during movement of the handle (102) from the move-up position to the deployed position.

19. The door handle assembly of claim 18, wherein the handle hinge assembly further comprises:
a first torsion spring (157) mounted on the first rotating shaft (186) and configured to abut between the connecting rod first end (140) and the door handle support (104) to provide a rotating force to rotate the connecting rod (114) about the first rotating shaft (186) in a clockwise direction, thereby enabling the connecting rod (114) to have a tendency to move from the deployed position to the move-up position and to the retracted position.

20. The door handle assembly of claim 13, further comprising:
an actuator (106) configured to drive the push block (108) to linearly reciprocate along the first direction (X).
